(19) United States
(12) Patent Application Publication
(10) Pub. No.: US 2003/0071076 A1
(43) Pub. Date: Apr. 17, 2003

(54) Concise fluid dispenser

(76) Inventors: Yael Toren Tenzer, Michmoret (IL); Mark Kapcic, Tel Aviv (IL); Shlomo Zucker, Michmoret (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 09/978,088

(22) Filed: Oct. 17, 2001

(51) Int. Cl. B67D 5/40

(52) U.S. Cl. 222/385

(57) ABSTRACT

A device for containing and dispensing a fluid that is capable of dispensing a predetermined quantity of a fluid on demand which is adaptable to a wide variety of purposes and which is small, flat and thin and may be easily distributed, attached to consumer products or carried by a user. Also shown is a method of dispensing single doses of a fluid.

### FIELD AND BACKGROUND OF THE INVENTION

The present invention relates to the field of fluid dispensers and, more particularly, to a fragrance dispenser capable of dispensing a measured quantity of a fragrance, the container being designed to be small, flat and thin and to be easily distributed, attached to consumer products or carried by a user.

The use of perfumes and fragrances to mask the natural scent of the human body and thereby to enhance the attractiveness of the wearer almost predates history, with evidence being found in ancient tombs and archeological sites. This practice continues today. Accordingly, the prior art reflects a long list of fragrance dispensers of all imaginable types, uses and configurations. See, for example U.S. Pat. No. 5,882,256 which shows a fragrance dispenser for a vehicle, U.S. Pat. No. 5,820,792 which discloses a perfume dispenser for an air conditioner, U.S. Pat. No. 5,820,791 which shows a perfume dispenser for an air treatment apparatus, U.S. Pat. No. 5,776,561 which discloses a fragrance dispensing silk flower comb, U.S. Pat. No. 5,704,162 which shows a fragrance emitting plant watering system, U.S. Pat. No. 4,964,570 which discloses a perfume dispenser in an article of jewelry, U.S. Pat. No. 4,785,642 which shows a decorative clip with a fragrance dispenser, U.S. Pat. No. 4,583,939 which discloses a combination cigarette lighter/perfume dispenser device, U.S. Pat. No. 4,244,525 which shows a writing instrument with a scent dispenser and U.S. Pat. No. 4,165,835 which discloses a fragrance dispenser and humidifier combination.

In addition, the prior art reflects fragrance dispensers that employ many different methods of dispensing the desired material, including U.S. Pat. Nos. D418,213 and D390,939 which show electric fragrance dispensers for insertion in a vehicle cigarette lighter socket, U.S. Pat. No. 5,526,960 which discloses a perfume dispenser with replaceable cartridges, U.S. Pat. No. 5,437,410 which shows a passive fragrance dispenser, U.S. Pat. No. 5,356,636 which discloses an extended release fragrance dispenser, U.S. Pat. No. 5,230,837 which shows a fragrance dispenser powered by a photovoltaic cell and U.S. Pat. No. 4,527,713 which discloses a coin operated fragrance dispenser.

Many of the devices cited in the prior art, as well as others not cited, are compact in design. Some are indeed so small as to be capable of being secreted on the body or in the clothing. All of the small dispensing devices use the principle of evaporation or volatilization in order to release scent agents and thus produce a fragrance. Such small devices do not have a variable dispensation rate nor a method of dispensing on demand. Rather, they dispense at a rate based upon the volatility of the material contained, the area exposed, the duration of the exposure and other environmental factors such as temperature, airflow, etc. that are not typically within the control of the user. An early and simple example of such a device may be found disclosed in U.S. Pat. No. 3,685,734 which describes a small and flat wafer-like device which emits a fragrance dissolved in a solvent by exposing a porous layer saturated with the volatile fluid. Another example may be found disclosed in U.S. Pat. No. 5,242,111 which describes a device which releases a fragrance by evaporation via a porous wick.

Many devices exist which allow a user to dispense a desired quantity of fragrance on demand. Such demand flow devices are typically bulky, containing a reservoir, a pump and a nozzle. Such devices may be found in the bathroom cabinets and on the dressing tables of most modem men and women. However, there is not known in the art a dispenser that combines small dimensions with the capability to dispense a measured dose of a fragrance or other fluid on demand.

There is thus a widely recognized need for a fluid dispenser that has a thin, flat and concise design and that allows a user to dispense on demand.

### SUMMARY OF THE INVENTION

Accordingly, it is an object of the present invention to provide a device that contains and dispenses a fragrance or other fluid that is small, flat and thin; that may be adapted to a wide variety of purposes that require the dispensation of a desired quantity of fluid on demand; and that may be conveniently distributed, attached to consumer products and carried by a user.

According to one aspect of the present invention there is provided a device for dispensing a fluid which comprises a flattened housing having two major sides arranged to include therebetween at least one reservoir for containing the fluid, at least one pumping mechanism for expelling the fluid which is operable through at least one of the two major sides, and at least one orifice serving as an outlet for the fluid.

According to another aspect of the present invention there is provided a method of distributing single doses of fluid comprising containing the fluid in a device which comprises a flattened housing having two major sides which contains therein at least one reservoir for containing the fluid, at least one pumping mechanism for expelling the fluid which is actuatable via a surface of the housing, and at least one orifice serving as an outlet for the fluid; and actuating the pumping mechanism such that the fluid is expelled from the reservoir via the outlet.

According to features in the described preferred embodiments the two major sides are sealed together at their common edge to form at least one reservoir.

According to features in the described preferred embodiments the reservoir is in fluid communication with the pumping mechanism such that the fluid contained within the reservoir is expellable by the pumping mechanism via the outlet.

According to features in the described preferred embodiments the housing contains at least one orifice serving as an inlet for a fluid, the inlet being in fluid communication with the reservoir.

According to features in the described preferred embodiments there is provided a one way valve interposed between the inlet and the reservoir, which serves to allow fluid to enter into the reservoir and to prevent fluid from escaping from the reservoir via the inlet.

According to features in the described preferred embodiments the pumping mechanism includes a closed hollow flexible chamber with a predetermined internal volume compressible by application of a force to cause its internal volume to be reduced and, being resilient, to return upon release of the force to its precompression volume.

According to features in the described preferred embodiments the pumping mechanism is hand operable through at least one of the two major sides of the housing.

According to features in the described preferred embodiments the force is applicable upon a pressure point on a side of the housing.

According to features in the described preferred embodiments the chamber includes an intake port in fluid communication with the reservoir and an emitting port in fluid communication with the outlet.

According to features in the described preferred embodiments the pumping mechanism further includes a one way valve interposed between the emitting port and the outlet which serves to allow fluid to be expelled from the chamber and dispensed via the outlet and to prevent fluid from entering the chamber; and a one way valve interposed between the intake port and the reservoir which serves to allow fluid to enter the chamber and to prevent fluid from being expelled from the chamber into the reservoir; such that when the chamber is compressed the fluid contained therein is expelled via the outlet and when the chamber resumes its precompression volume fluid contained within the reservoir is drawn into the chamber via the intake port.

According to features in the described preferred embodiments the pumping mechanism comprises a pressurized gas expulsion mechanism for using pressurized gas to expel the fluid contained in the reservoir from the outlet.

According to features in the described preferred embodiments the fluid is a particulate material that can flow in a fluid manner controllable by the pumping mechanism.

According to features in the described preferred embodiments the housing is substantially sized and shaped as a credit card, calling card, flyer, greeting card, price tag or bookmark.

According to features in the described preferred embodiments the housing is enclosed within a credit card, calling card, flyer, greeting card, price tag, bookmark, book, booklet, pamphlet or envelope.

According to features in the described preferred embodiments at least one of the major surfaces comprises a printing surface.

According to features in the described preferred embodiments the fluid comprises a fragrance or a medicament.

The present invention successfully addresses the shortcomings of the presently known configurations by providing a device and method of dispensing a fluid that is small, flat and thin, is able to dispense a predetermined quantity of fluid on demand and is capable of being applied to many uses.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 is a diagrammatic front view of a fluid dispenser constructed in accordance with an embodiment of the present invention;

FIG. 2 is a diagrammatic side view of the device of FIG. 1;

FIG. 3 is a diagrammatic sectional view of the device of FIG. 1 and FIG.4 is a diagrammatic sectional view of a valve that is a feature of the device of FIG. 1.

### DESCRIPTION OF THE PREFERRED EMBODIMENTS

Before explaining at least one embodiment of the invention in detail, it is to be understood that the invention is not limited in this application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The principles and operation of a fluid dispenser according to the present invention may be better understood with reference to the drawings and accompanying descriptions.

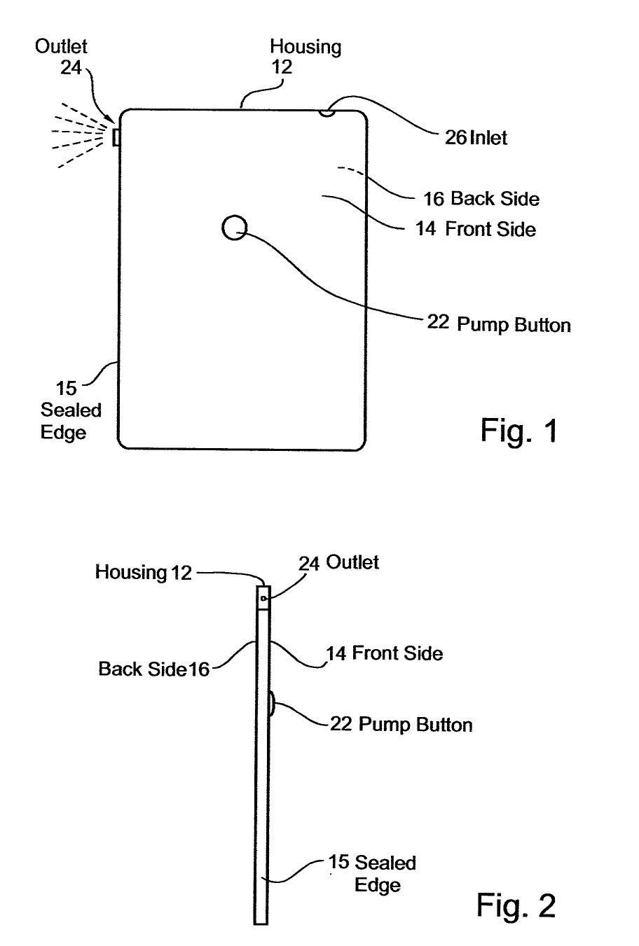

Reference is made to FIGS. 1 and 2 which show a fluid dispenser in accordance with the teachings of the present invention, which is referred to hereinafter as dispenser 10. Dispenser 10 comprises a housing, referred to hereinafter as housing 12, which comprises two major sides, front side 14 and back side 16 which, in the preferred embodiment, are parallel to one another. Housing 12 may be rigid or semi rigid, constructed of a plastic or thermoplastic polymer material, or may be flexible, constructed of a flexible material such as polyethylene or polyvinyl chloride. It is appreciated that the material from which housing 12 is constructed is not a salient feature of device 10 and any present or future material will suffice provided that such material has the requisite structural characteristics and is capable of retaining the fluid contents without seepage or dissolution.

Housing 12 may be of any shape and size, although most embodiments of the invention require a compact and concise size. It is one of the features of device 10 to be useful as a container for certain fluids that have recognized commercial identities. Accordingly, it is expected that various embodiments of device 10 will be in shapes and sizes that are associated with the fluid contained therein. In this same respect, it is a feature of housing 12 that one or both of sides 14 and 16 will comprise a printing surface on which text or graphic images associated with the contents may be imprinted. For example, an embodiment of device 10 for dispensing a certain perfume may have a similar shape and graphic design as the commercial packaging in which the perfume in question is customarily marketed.

Sides 14 and 16 are sealed around their common edges at a predetermined distance apart so as to form a reservoir therebetween wherein the fluid is contained. The form of sealing is not a material feature and any bonding agent that will produce an impenetrable seal will suffice. The distance apart will determine the capacity of the reservoir thus formed. According to the preferred embodiment, the distance between sides 14 and 16 is approximately 2-3 mm in order that the thickness of device 10 remain small, although it will be appreciated that the distance between sides 14 and 16 may be larger or smaller, consistent with the requirements of the relevant use of device 10.

The preferred embodiment of device 10 is as a dispenser for a fragrance. However, it is understood that device 10 may contain and dispense any fluid with a viscosity that allows it to flow, including volatile fluids, non-volatile fluids, oils, and powders composed of particulate material. Such fluids may have a broad range of uses and purposes such as fragrances, medicaments, fungicides, herbicides, insect repellants, lubricants, corrosion inhibitors, food additives or beverages. An example of a particulate material which behaves like a fluid and which may be dispensed by the preferred embodiment is powdered graphite which is used as a lubricant. It is appreciated that device may be so designed and configured to contain and dispense a desired predetermined quantity of the relevant fluid.

Device 10 has an inlet 26 which penetrates housing 12 and is in fluid communication with the reservoir formed between sides 14 and 16. The purpose of inlet 26 is to allow the introduction of fluid into the reservoir and to allow the entry of air into the reservoir in order to equalize the vacuum caused by the dispensation of fluid from device 10. The entry of fluid and air via inlet 26 is controlled by a one-way valve that will be discussed hereinafter. Inlet 26 may be located anywhere on device 10 and may be incorporated into the design of housing 12 for purposes of utility or esthetics.

Device 10 has an outlet from which the fluid is dispensed, hereinafter outlet 24. Outlet 24 may also be located anywhere on device 10 and may be incorporated into the design of housing 12 for purposes of utility or esthetics. For example, outlet 24 may be located at the end of an extending protuberance which is a part of the shape of housing 12 for the purpose of precisely depositing eye drops in the eyes of a user. Outlet 24 may have a larger or smaller diameter as determined by the requirements of the relevant use. Outlet 24 may be configured with a variable sized diameter in order to allow a user to adjust the flow. Moreover, outlet 24 may be designed and configured to deliver different modes of dispensation, in accordance with the intended use. For example, a spray might be desired for a lubricant whereas a mist might be more appropriate for a fragrance. Droplets might be the preferred method of applying an insect repellant. The present invention contemplates outlet 24 being of any size, shape or configuration consistent with the desired purpose.

The dispensation of the fluid is caused by a pumping mechanism, discussed in detail hereinafter, which is located within housing 12. The pumping mechanism responds to the application of pressure on pump button 22 which protrudes through side 14. According to the preferred embodiment, a user actuates and hand operates the pumping mechanism via side 14 of housing 12 by pressing on pump button 22.

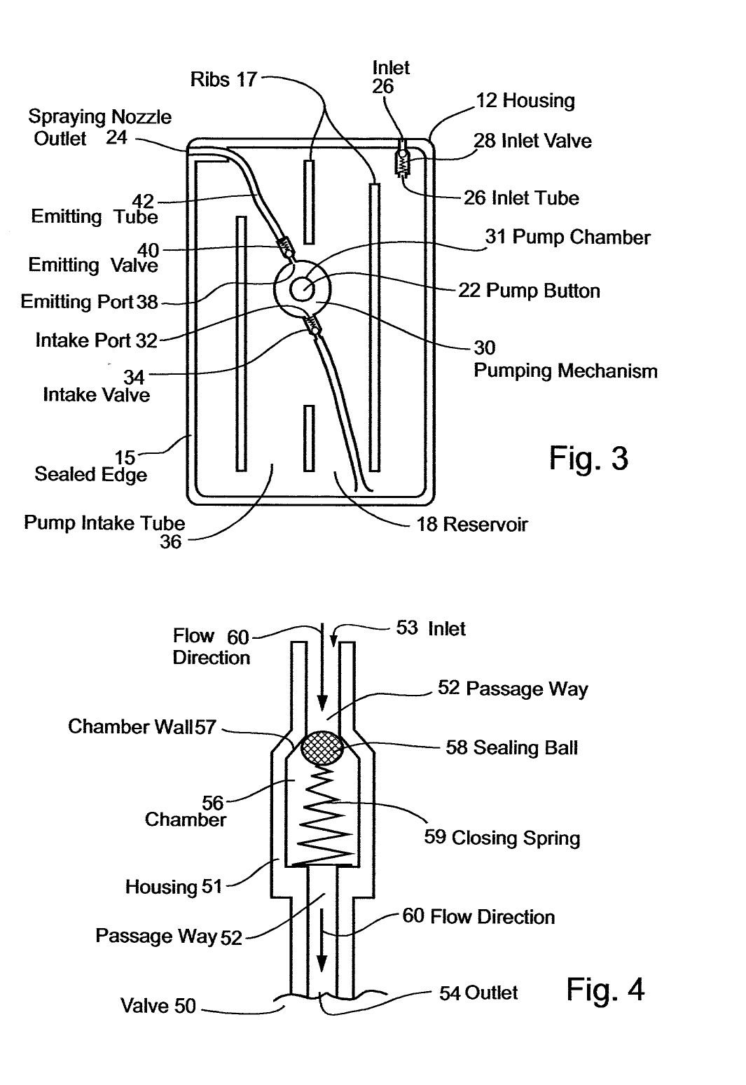

Reference is now made to FIG. 3 wherein the interior of the preferred embodiment of device 10 is depicted in a sectional view. Shown is the interior of housing 12, which in the preferred embodiment is also the interior of the reservoir, hereinafter referred to as reservoir 18. The common identity of the interiors of housing 12 and reservoir 18 is caused by the seal of the edges of sides 14 and 16 forming the outer edges of reservoir 18. In order for the seal to serve as the reservoir, it is essential that it be fluid-tight with respect to the relevant fluid. It is appreciated that reservoir 18 could also be formed of a separate fluid-tight bladder device that is held within housing 12, thus obviating the need for a fluid tight seal between the edges of sides 14 and 16.

According to the preferred embodiment, there is interposed between sides 14 and 16 a series of parallel longitudinal ribs, hereinafter ribs 17, for the purpose of maintaining the desired separation of sides 14 and 16. It will be noted that ribs 17 do not extend from edge to edge within reservoir 18 so that they do not compartmentalize reservoir 18 such that fluid is trapped in a closed compartment. All fluid therein is in communication with inlet 26 and may freely flow throughout reservoir 18.

Shown between sides 14 and 16 and within reservoir 18 is a pumping mechanism, hereinafter referred to as pump 30. According to the preferred embodiment, pump 30 includes a closed, hollow and flexible chamber, hereinafter pump chamber 31, which can be compressed by the application of force on its outer wall. Housing 12 is so constructed that a portion of the outer wall of pump chamber 31 extends through side 14 thereof and is visible and palpable by a user. The portion that extends therethrough and is visible constitutes the previously referred to pump button 22 which actuates pump 30 by the pressure of a finger or hand of a user exerted on pump chamber 31.

Pump chamber 31 is in fluid communication with reservoir 18 via an opening therein referred to hereinafter as intake port 32. Intake port 32 is the entry point into pump chamber 31 for fluid in the reservoir to begin the pumping process ultimately to be dispensed through outlet 24. The entry of fluid from reservoir 18 into pump chamber 31 is governed by a one-way valve, hereinafter intake valve 34, interposed therebetween. Intake valve 34 allows fluid to pass from reservoir 18 into pump chamber 31 but does not allow fluid to pass from pump chamber 31 into reservoir 18. Pump intake tube 36 extends from the inlet of intake valve 34 into the reservoir to facilitate the entry of fluid into intake valve 34.

Pump chamber 31 is in fluid communication with outlet 24 via an opening therein referred to hereinafter as emitting port 38. Emitting port 38 is the exit point for fluids being expelled from pump chamber 31. Such fluids may be forced by the pumping action of pump 30 to pass through emitting port 38 and thereafter through emitting tube 42 which conducts the fluid, to outlet 24 to be dispensed. Interposed between emitting port 38 and emitting tube 42 is a one-way valve, hereinafter referred to as emitting valve 40. Emitting valve 40 allows fluids within pump chamber 31 to pass into emitting tube 42 but does not allow fluid to pass from emitting tube 42 into pump chamber 31. Emitting valve 40 also serves the additional purpose of requiring a certain level of pressure in order for it to open and allow the fluid to pass therethrough. Therefore, the fluid passing through emitting valve 40 will be emitted with a certain predetermined minimum pressure.

Accordingly, the pumping action of pump 30 is controlled by the above described two valves in series to assure that fluid within reservoir 18 moves solely in the direction of outlet 24.

The pumping action of pump 30 is caused by pressure exerted on pump chamber 31 which is compressed as a result of the pressure, thereby decreasing its internal volume. When the volume of pump chamber 31 is decreased, it expresses its fluid contents through emitting port 38. This fluid may exit pump chamber 31 only via emitting port 38 because emitting valve 40 allows the fluid to pass out of pump chamber 31, whereas intake valve 34 does not allow the fluid to pass through. When the pressure is released, pump chamber 31, being constructed of a resilient material, strives to resume its former shape and volume. The resilient force of the material as it resumes its former shape is sufficient to draw in by suction any fluid with which pump chamber 31 is in communication. Such fluid may only enter pump chamber 31 from reservoir 18 via intake port 32 because intake valve 34 allows the fluid to pass through into pump chamber 31, whereas emitting valve 40 does not allow fluid to pass through. The resulting withdrawal of fluid from reservoir 18 into pump chamber 31 results in a vacuum forming within reservoir 18 which is equalized by the entry of air into reservoir 18 via inlet 26. Air entering inlet 26 passes through inlet valve 28. Inlet valve 28 is a one-way valve allowing a fluid to enter reservoir 18 through inlet 28 but not to escape from reservoir 18 via inlet 26.

It is appreciated that the size of pump chamber 31 may vary in the different embodiments of the invention. Similarly, intake port 32 and emitting port 38 may also be of different sizes in order to accommodate the flow characteristics of the relevant fluid and /or the desired quantity of dispensation desired.

It is also to be appreciated that device 10 may employ different types of pumping mechanisms as may be appropriate in different applications. For example, a pressurized gas assisted pumping mechanism, such as compressed air or a gas generating cell, may be employed in applications where a larger quantity of a more viscous fluid must be dispensed.

Reference is now made to FIG. 4 which is a simplified diagram showing a one way valve suitable for use in place of above-mentioned inlet valve 28, intake valve 34 and emitting valve 40. Valve 50 is depicted in a sectional view. Valve 50 comprises housing 51 which serves as an outer casing of the valve and contains all valve components therein and which is preferably made of a thermoplastic material such as nylon, polystyrene, acrylonitrile-butadiene-styrene (ABS) polymers and the like; passageway 52 which is the channel through housing 51 through which fluid passes; inlet 53 which is the entryway for fluid into passageway 52 flowing in the direction of arrow 60; outlet 54 which is the exit point for the fluid passing through passageway 52; chamber 56 formed by the widening of passageway 52 to form a hollow tubular atrium the interior surface of which is designated chamber wall 57; sealing ball 58 deposed within chamber 56 which is forced under pressure of a coil spring, referred to hereinafter as closing spring 59, to seat against chamber wall 57 at the point that passageway 52 widens to form chamber 56, thus sealing passageway 52 and preventing flow therethrough. When fluid enters inlet 53 and flows in the direction of arrow 60 into passageway 52, the force of the flow overcomes the force of closing spring 59 on sealing ball 58. The fluid thus moves sealing ball 58 away from chamber wall 57, passes into chamber 56 and therefrom into passageway 52 in the direction of outlet 54. Fluid flow in the opposite direction will be prevented by sealing ball 58 being seated against chamber wall 57 as described above.

It is understood that other types of one-way valves may also be employed, as may be appropriate in relevant circumstances. Such valves include but are not limited to trap door valves in which a flap of material opens the passageway when the fluid flows in one direction and closes the passageway when the fluid flows in the opposite direction; or a mitral valve which has two flaps of material, roughly in the shape of the Pope's miter, which are forced apart when the fluid flows in one direction and are forced together when the fluid flows in the opposite direction.

It is further understood that the invention is capable of many variations and embodiments, as the need dictates. Such embodiments include, but are not limited to, a dispenser that is for one-time-use only and thus has no valves or inlet, all of its fluid content being dispensed in one compression of pump chamber 31; or an embodiment which includes two or more systems comprising an inlet, outlet, reservoir and pumping mechanism which can be used for dispensing two or more different fluids.

It is understood that the present invention is capable of multiple applications. It is useful as a disposable applicator for personal substances such as fragrances, medicaments, insect repellants, grooming substances, etc. It is further applicable for commercial use, serving as an attractive and low cost method of distributing samples of marketed fluids for promotional purposes. The present invention is adaptable for specific brand identification by being configured in recognizable shapes, colors and designs, including proprietary text and graphics. The invention is further useful as a method of adding an olfactory element to the packaging of consumer products. Price tags and other informational appurtenances that incorporate the invention may be affixed to all manner of commercial products to enhance brand recognition. The packaging of leisure products including entertainment products such as books, magazines, compact disks, etc. may be made more desirable by the addition of a scent emitting element. The list goes on. There is almost no limit to the uses a creative entrepreneur may find for the invention.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather, the scope of the present invention is defined by the appended claims and includes both combinations and subcombinations of the various features described hereinabove as well as variations and modifications thereof which would occur to persons skilled in the art upon reading the foregoing description. Accordingly, it is intended to embrace all such alternatives, modifications and variations that fall within the spirit and broad scope of the appended claims.

What is claimed is:

1. A device for dispensing a fluid, comprising a flattened housing having two major sides, arranged to include therebetween at least one reservoir for containing said fluid; at least one pumping mechanism for expelling said fluid; and at least one orifice serving as an outlet for said fluid; said pumping mechanism being operable through at least one of said two major sides.

2. The device of claim 1, wherein said two major sides are sealed together at their common edge to form said at least one reservoir.

3. The device of claim 1, wherein said reservoir is in fluid communication with said pumping mechanism such that said fluid contained within said reservoir is expellable by said pumping mechanism via said outlet.

4. The device of claim 1, wherein said housing contains at least one orifice serving as an inlet for a fluid, said inlet being in fluid communication with said reservoir.

5. The device of claim 4, wherein a one way valve is interposed between said inlet and said reservoir, said one way valve serving to allow fluid to enter into said reservoir and to prevent fluid from escaping from said reservoir via said inlet.

6. The device of claim 1, wherein said pumping mechanism includes a closed hollow flexible chamber with a predetermined internal volume compressible by application of a force to cause its internal volume to be reduced and being resilient, thereby to return, upon release of said force, to its precompression volume.

7. The device of claim 6, wherein said compressive force is applicable upon a pressure point on a side of said housing.

8. The device of claim 6, wherein said chamber includes an intake port in fluid communication with said reservoir and an emitting port in fluid communication with said outlet.

9. The device of claim 8, wherein said pumping mechanism further includes a one way valve interposed between said emitting port and said outlet, said valve serving to allow fluid to be expelled from said chamber and dispensed via said outlet and to prevent fluid from entering said chamber; and a one way valve interposed between said intake port and said reservoir, said valve serving to allow fluid to enter said chamber and to prevent fluid from being expelled from said chamber into said reservoir; such that when said chamber is compressed fluid contained therein is expelled via said outlet and when said chamber resumes its precompression volume fluid contained within said reservoir is drawn into said chamber via said intake port.

10. The device of claim 1, wherein said pumping mechanism comprises a pressurized gas expulsion mechanism for using pressurized gas to expel said fluid contained in said reservoir from said outlet.

11. The device of claim 1, wherein said fluid is a particulate material that can flow in a fluid manner controllable by said pumping mechanism.

12. The device of claim 1, wherein said housing is substantially sized and shaped as a credit card, calling card, flyer, greeting card, price tag or bookmark.

13. The device of claim 1, wherein said housing is enclosed within a credit card, calling card, flyer, greeting card, price tag, bookmark, book, booklet, pamphlet or envelope.

14. The device of claim 1, wherein at least one of said major surfaces comprises a printing surface.

15. The device of claim 1, wherein said fluid comprises a fragrance.

16. The device of claim 1, wherein said fluid comprises a medicament.

17. A method of distributing single doses of fluid, the method comprising: containing said fluid in a device comprising a flattened housing having two major sides, containing therein at least one reservoir for containing said fluid, at least one pumping mechanism for expelling said fluid actuatable via a surface of said housing, and at least one orifice serving as an outlet for said fluid; and actuating said pumping mechanism such that said fluid is expelled from said reservoir via said outlet.

18. The method of claim 17 wherein said pumping mechanism is hand-operable through at least one of said two major sides.

19. The method of claim 17, wherein said fluid comprises a fragrance.

20. The method of claim 17, wherein said fluid comprises a medicament.

21. The method of claim 17, wherein said housing is substantially sized and shaped as a credit card, calling card, flyer, greeting card, price tag or bookmark.

22. The method of claim 17, wherein said housing is enclosed within a credit card, calling card, flyer, greeting card, price tag, book, booklet, bookmark, pamphlet or envelope.

23. The method of claim 17, wherein at least one of said major surfaces comprises a printing surface.
